(19) United States
(12) Patent Application Publication
(10) Pub. No.: US 2013/0282332 A1
(43) Pub. Date: Oct. 24, 2013

(54) METHOD OF OBTAINING LINEAR CURVE FITTING CONVERSION EQUATION FOR USE WITH NON-LINEAR MEASUREMENT SYSTEM

(71) Applicants: SHENG-HUI YANG, NEW TAIPEI CITY (TW); CHIEN-CHIH WU, NEW TAIPEI CITY (TW)

(72) Inventors: SHENG-HUI YANG, NEW TAIPEI CITY (TW); CHIEN-CHIH WU, NEW TAIPEI CITY (TW)

(73) Assignees: ASKEY COMPUTER CORP.; ASKEY TECHNOLOGY (JIANGSU) LTD.

(21) Appl. No.: 13/557,538

(22) Filed: Jul. 25, 2012

(30) Foreign Application Priority Data
Apr. 24, 2012 (TW) 101114501

(51) Int. Cl. G06F 17/18

(52) U.S. Cl. 702/179

(57) ABSTRACT

A method of obtaining a linear curve fitting conversion equation for use with a non-linear measurement system is introduced. The linear curve fitting conversion equation converts a subject value entered into the non-linear measurement system into a measured value for simulating a linear curve. The method includes substituting a known preset input value, an output value generated by entering the preset input value into the non-linear measurement system, and n operator settings falling within the measurement range of the non-linear measurement system into a (n-1)^{th} order polynomial to form simultaneous equations including a number n of polynomials and thereby obtain a fitting parameter for creating the linear curve fitting conversion equation for use with the non-linear measurement system, thereby dispensing with the hassles of processing a large amount of data required for creating a conversion rule.

### CROSS-REFERENCE TO RELATED APPLICATION

This non-provisional application claims priority under 35 U.S.C. §119(a) on Patent Application No(s). 101114501 filed in Taiwan, R.O.C. on Apr. 24, 2012, the entire contents of which are hereby incorporated by reference.

### FIELD OF TECHNOLOGY

The present invention relates to methods of obtaining a linear curve fitting conversion equation, and more particularly, to a method for fitting a linear curve relationship from a non-linear measurement system.

### BACKGROUND

Production lines are usually equipped with plenty of measurement devices for performing quality control on products. If the operational components of the measurement devices are non-linear, the results of measurement are seldom predictable. As a result, it is necessary to create an expensive database whereby, after the measurement device has received and converted an input signal into an output value, the output value generates a measure value.

Referring to FIG. 1, there is shown a function block diagram of a conventional measurement system 100. The measurement system 100 comprises a sensing element 110, an operational circuit 120, an analog to digital converter 130, a processor 140, and a memory unit 150. The sensing element 110 receives and senses an input signal S. and sends the input signal S. to the operational circuit 120. The operational circuit 120 and the analog to digital converter 130 perform an operational process on the input signal S. to convert the input signal S. into an output value out1 in a digital format. The processor 140 receives the output value out1 and then outputs a measure value out2 based on the output value out1 and related data stored in the memory unit 150.

Alternatively, the measurement range of a measurement system is divided into several segments. Any value entered into the measurement system has a linear relationship with an output value, so as to dispense with the hassles of creating a table of data or even a database that contains all the values which fall into each of the segments of the measurement range. However, segmentation and regulation incur high costs.

### SUMMARY

It is an objective of the present invention to simplify a method of obtaining a linear curve fitting conversion equation for use with a non-linear measurement system.

Another objective of the present invention is to provide a precise linear curve fitting conversion equation for use with a non-linear measurement system.

In order to achieve the above and other objectives, the present invention provides a method of obtaining a linear curve fitting conversion equation for use with a non-linear measurement system. The linear curve fitting conversion equation converts a subject value, which is sent to the non-linear measurement system, into a measure value for simulating a linear curve so as to render the non-linear measurement system predictable. The method comprises the steps of: a: setting a number n, the number n being a positive integer; b: setting a number n of operational groups within the measurement range of the non-linear measurement system, wherein each operational group includes a preset input value and an output value generated as a result of the preset input value sent to and received by the non-linear measurement system, wherein the preset input value and the output value are different; c: substituting each of the operational groups into O=pₙIⁿ⁻¹+pₙ₋₁Iⁿ⁻²+ . . . +p₂I¹+p₁I⁰ to construct simultaneous equations which comprise a number n of polynomials, wherein the preset input value of each operational group is denoted with O, the output value of each operational group with I, and the fitting parameter with P; d: solving the simultaneous equations composed of polynomials to obtain the fitting parameters; and e: substituting the fitting parameters into O=pₙIⁿ⁻¹+pₙ₋₁Iⁿ⁻²+ . . . +p₂I¹+p₁I⁰ the linear curve fitting conversion equation, wherein the measure value of the non-linear measurement system is denoted with O of the linear curve fitting conversion equation and the subject value of the non-linear measurement system is denoted with I.

In an embodiment, in step b, the preset input values of the operational groups are uniformly distributed within the measurement range of the non-linear measurement system. Furthermore, the preset input values of the operational groups start with a first value of the measurement range and end with a last value of the measurement range, wherein an interval value of the preset input values is the quotient of the measurement range value divided by the number n.

In an embodiment, the method of obtaining a linear curve fitting conversion equation for use with a non-linear measurement system further comprises a process of testing the linear curve fitting conversion equation. The testing process comprises the steps of: f1: setting a group number of the test groups to at least five times the number n, the test groups each comprising a preset test input value and a measure test value generated as a result of entering the preset test input value into the linear curve fitting conversion equation, wherein the preset test input value and the measure test value are different; f2: obtaining a coefficient of correlation between the measure test value and the preset test input value of the test groups; and f3: determining whether the correlation coefficient is not less than a test threshold value, and going back to step a in response to a negative determination to set a larger number n.

In an embodiment, in step f1, the group number of the test groups is set to at least ten times the number n.

In an embodiment, in step f1, the preset test input values of the test groups start with a first value of the measurement range and end with a last value of the measurement range, and an interval value of the preset test input values is a quotient of the measurement range value divided by the group number of the test groups.

In an embodiment, in step f3, the test threshold value is 99.9%.

Accordingly, a linear curve fitting conversion equation for use with a non-linear measurement system can be constructed easily and precisely to dispense with the conventional time-consuming process of data compilation and thereby cut production costs.

### BRIEF DESCRIPTION OF THE DRAWINGS

Objectives, features, and advantages of the present invention are hereunder illustrated with specific embodiments in conjunction with the accompanying drawings, in which:

FIG. 1 (PRIOR ART) is a function block diagram of a conventional measurement system;

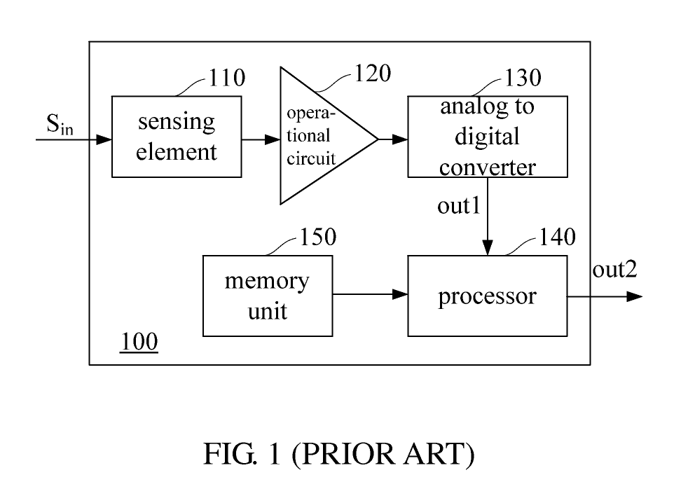

FIG. 2 is a flow chart of a method of obtaining a linear curve fitting conversion equation for use with a non-linear measurement system according to an embodiment of the present invention; and

FIG. 3 is a flow chart of a process of testing a linear curve fitting conversion equation for use with a non-linear measurement system according to an embodiment of the present invention.

### DETAILED DESCRIPTION

A linear curve fitting conversion equation for use with a non-linear measurement system according to the present invention is stored in a memory unit 150. An input signal Sᵢₙ, entered into the non-linear measurement system is converted into an output value out1, and then the output value out1 is precisely converted into a measure value out2. During the construction process of the linear curve fitting conversion equation, the output of the linear curve fitting conversion equation is a preset input value (for example, an input signal Sᵢₙ, generated by a specific signal generation instrument and characterized by a known strength value) to the non-linear measurement system. The output generated from the non-linear measurement system serves as the input to the linear curve fitting conversion equation (for example, the output value out1 serves as the input to the linear curve fitting conversion equation.)

During the testing process of the linear curve fitting conversion equation, the input signal Sᵢₙ, of the non-linear measurement system is a preset test input value (for example, an input signal Sᵢₙ generated by a specific signal generation instrument and characterized by a known strength value,) whereas the measure value out2 of the non-linear measurement system is a measure test value generated by the linear curve fitting conversion equation from the output of the non-linear measurement system (for example, the measure value out2 is treated as the output of the non-linear measurement system.)

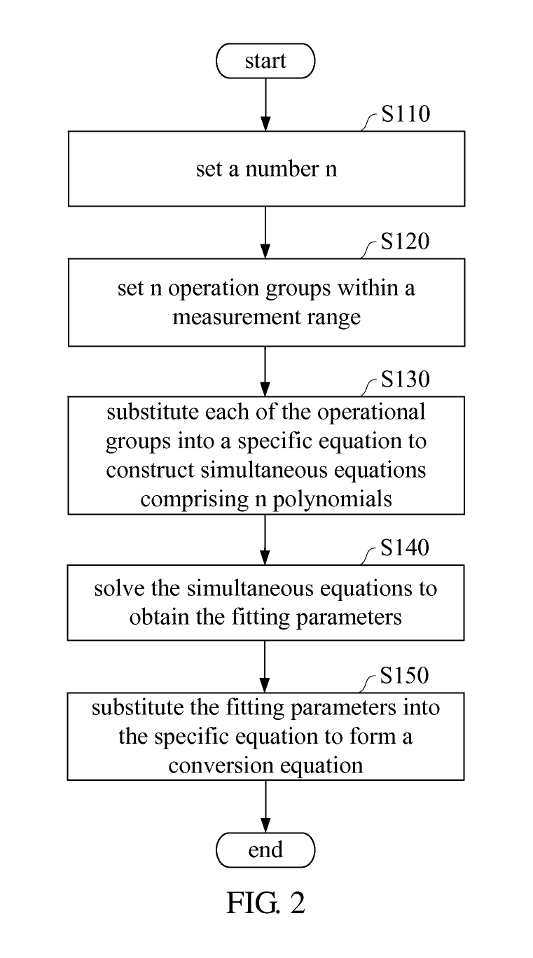

Referring to FIG. 2, there is shown a flow chart of a method of obtaining a linear curve fitting conversion equation for use with a non-linear measurement system according to an embodiment of the present invention.

As shown in FIG. 2, the method comprises the following steps.

Step S110: setting a number n, wherein the number n is a positive integer and is preferably at least 3.

Step S120: setting a number n of operation groups within a measurement range of the non-linear measurement system, wherein each operational group includes a preset input value and an output value which are different. The output value is generated as a result of the preset input value sent to and received by the non-linear measurement system. That is to say, the operational groups contain different preset input values and output values corresponding thereto, respectively. The measurement range of the non-linear measurement system is defined as the “measurable” range of the non-linear measurement system; hence, it is impossible for the non-linear measurement system to work outside the measurement range thereof

Step S130: substituting each of the operational groups into equation (1) below to construct simultaneous equations which comprise a number n of polynomials.

O=pₙIⁿ⁻¹+pₙ₋₁Iⁿ⁻²+ . . . +p₂I¹+p₁I⁰ (1)

where the preset input value of each operational group is denoted with O, the output value of each operational group with I, and the fitting parameter with P. Upon substitution, each operational group brings about an equation. Every P is solved by n unknown “P”s and n equations.

Step S140: solving the simultaneous equations composed of polynomials to obtain the fitting parameters. The polynomials can be solved by matrix row operations or any appropriate mathematical methods, which is well known among persons skilled in the art and thus is not reiterated herein for the sake of brevity.

Step S150: substituting the fitting parameters Pₙ, Pₙ₋₁, . . . into equation (1) to form the linear curve fitting conversion equation, wherein the measure value of the non-linear measurement system is denoted with O of the linear curve fitting conversion equation and the subject value of the non-linear measurement system is denoted with I.

Upon completion of the aforesaid process flow, the construction of the linear curve fitting conversion equation is done.

To render the linear curve fitting conversion equation thus constructed more widely applicable and more accurate, the method of the prevention invention further comprises, in step b, the preset input values of the operational groups are uniformly distributed within the measurement range of the non-linear measurement system. Preferably, the preset input values of the operational groups start with the first value of the measurement range and end with the last value of the measurement range, wherein the interval value of the preset input values is the quotient of the measurement range value divided by the number n.

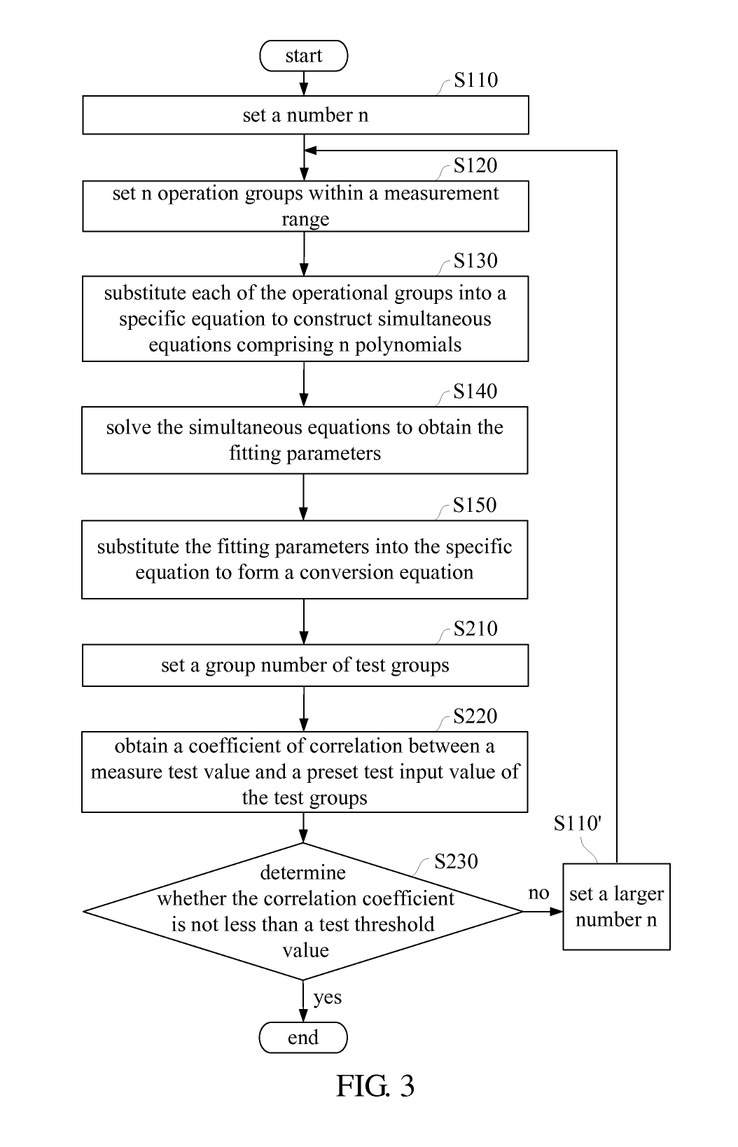

Referring to FIG. 3, there is shown a flow chart of a process of testing a linear curve fitting conversion equation for use with a non-linear measurement system according to an embodiment of the present invention. To render the linear curve fitting conversion equation more precise, step S150 is followed by the following steps.

Step S210: setting a group number of the test groups to at least five times the number n, the test groups each comprising a preset test input value and a measure test value generated as a result of entering the preset test input value into the linear curve fitting conversion equation, wherein the preset test input value and the measure test value are different. Preferably, step S210 involves setting a group number of the test groups to at least ten times the number n.

Step S220: obtaining a coefficient of correlation between the measure test value and the preset test input value of the test groups. The correlation coefficient is a standardized association coefficient and is calculated by: calculating the covariance of two variables (preset test input value and the measure test value); removing discreteness and unit discrepancy (i.e., standard deviation) from the two variables; standardizing the two variables to obtain a standardized fraction whose unit is removed; and multiplying the absolute value of the standardized fraction by 100%. The mathematical methodology applicable to step S220 is well known among persons skilled in the art and thus is not reiterated herein for the sake of brevity.

Step S230: determining whether the correlation coefficient is not less than a test threshold value. Preferably, the test threshold value is 99.9%. End the process flow, if the determination is affirmative. Go to step S110′, if the determination is negative.

Step S110′: setting a larger number n. Step S110′ is followed by step S120.

In conclusion, a method of obtaining a linear curve fitting conversion equation for use with a non-linear measurement system according to the present invention can be obtained easily and precisely to dispense with the hassles of performing a time-consuming process of compiling a large amount of data and thereby cut production costs.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A method of obtaining a linear curve fitting conversion equation for use with a non-linear measurement system and for use in converting a subject value entered into the non-linear measurement system into a measure value for simulating a linear curve, the method comprising the steps of:
a: setting a number n, the number n being a positive integer;
b: setting n operational groups within a measurement range of the non-linear measurement system, the operational groups each comprising a preset input value and an output value generated as a result of entering the preset input value into the non-linear measurement system, wherein the preset input value and the output value are different;
c: substituting each of the operational groups into O=pₙIⁿ⁻¹+pₙ₋₁Iⁿ⁻²+ . . . +p₂I¹+p₁I⁰ to construct simultaneous equations comprising a number n of polynomials, wherein the preset input value of each operational group is denoted with O, the output value of each operational group with I, and the fitting parameter with P;
d: solving the simultaneous equations composed of polynomials to obtain the fitting parameters; and
e: substituting the fitting parameters into O=pₙIⁿ⁻¹+pₙ₋₁Iⁿ⁻²+ . . . +p₂I¹+p₁I⁰ form the linear curve fitting conversion equation, wherein the measure value of the non-linear measurement system is denoted with O of the linear curve fitting conversion equation and the subject value of the non-linear measurement system is denoted with I.

2. The method of claim 1, wherein, in step a, the number n is at least 3.

3. The method of claim 1, wherein in step b, the preset input values of the operational groups are uniformly distributed within the measurement range of the non-linear measurement system.

4. The method of claim 3, wherein, in step b, the preset input values of the operational groups start with a first value of the measurement range and end with a last value of the measurement range, wherein an interval value of the preset input values is the quotient of the measurement range value divided by the number n.

5. The method of claim 1, further comprising a process of testing the linear curve fitting conversion equation, the testing process comprising the steps of:
f1: setting a group number of the test groups to at least five times the number n, the test groups each comprising a preset test input value and a measure test value generated as a result of entering the preset test input value into the linear curve fitting conversion equation, wherein the preset test input value and the measure test value are different;
f2: obtaining a coefficient of correlation between the measure test value and the preset test input value of the test groups; and
f3: determining whether the correlation coefficient is not less than a test threshold value, and going back to step a in response to a negative determination to set a larger number n.

6. The method of claim 5, wherein, in step f1, the group number of the test groups is set to at least ten times the number n.

7. The method of claim 5, wherein, in step f1, the preset test input values of the test groups start with a first value of the measurement range and end with a last value of the measurement range, and an interval value of the preset test input values is a quotient of the measurement range value divided by the group number of the test groups.

8. The method of claim 5, wherein, in step f3, the test threshold value is 99.9%.
